(19) United States
(12) Patent Application Publication
(10) Pub. No.: US 2023/0075106 A1
(43) Pub. Date: Mar. 9, 2023

(54) ULTRASONIC PROBE AND ULTRASONIC INSPECTION DEVICE

(71) Applicant: KABUSHIKI KAISHA TOSHIBA, Tokyo (JP)

(72) Inventors: Tsuyoshi KOBAYASHI, Kawasaki Kanagawa (JP); Tomio ONO, Yokohama Kanagawa (JP); Norihiko TANAKA, Yokohama Kanagawa (JP); Tomonori ABE, Yokohama Kanagawa (JP)

(73) Assignee: KABUSHIKI KAISHA TOSHIBA, Tokyo (JP)

(21) Appl. No.: 17/678,359

(22) Filed: Feb. 23, 2022

(30) Foreign Application Priority Data
Sep. 7, 2021 (JP) 2021-145620

(51) Int. Cl. G01N 29/34; G01N 29/24; G01N 29/04

(52) U.S. Cl. CPC G01N 29/348; G01N 29/2437; G01N 29/04; G01N 2291/023; G01N 2291/104

(57) ABSTRACT

According to one embodiment, an ultrasonic probe includes a first vibrating element and a second vibrating element. The first vibrating element is configured to vibrate at a first peak frequency. An intensity of a vibration of the first vibrating element is highest at the first peak frequency. The second vibrating element is configured to vibrate at a second peak frequency lower than the first peak frequency. An intensity of a vibration of the second vibrating element is highest at the second peak frequency.

### CROSS-REFERENCE TO RELATED APPLICATIONS

This application is based upon and claims the benefit of priority from Japanese Patent Application No. 2021-145620, filed on Sep. 7, 2021; the entire contents of which are incorporated herein by reference.

### FIELD

Embodiments described herein generally relate to an ultrasonic probe and an ultrasonic inspection device.

### BACKGROUND

For example, there is an inspection device using ultrasonic waves or the like. It is desired to improve the accuracy of ultrasonic probes and ultrasonic inspection devices.

### BRIEF DESCRIPTION OF THE DRAWINGS

FIGS. 1A and 1B are schematic cross-sectional views illustrating an ultrasonic probe according to the first embodiment;

FIG. 2 is a schematic view illustrating an operation of the ultrasonic probe and the ultrasonic inspection device according to the first embodiment;

FIGS. 3A and 3B are schematic views illustrating the characteristics of the ultrasonic probe according to the first embodiment;

FIG. 4 is a schematic view of the ultrasonic probe according to the first embodiment;

FIG. 5 is a schematic view illustrating the characteristics of the ultrasonic probe according to the first embodiment;

FIG. 6 is a graph illustrating the characteristics of the ultrasonic probe;

FIGS. 7A and 7B are schematic cross-sectional views illustrating an ultrasonic probe according to a second embodiment;

FIG. 8 is a schematic cross-sectional view illustrating the ultrasonic probe according to the second embodiment;

FIGS. 9A and 9B are schematic cross-sectional views illustrating an ultrasonic probe according to the embodiment; and

FIG. 10 is a schematic cross-sectional view illustrating an ultrasonic probe according to the embodiment.

### DETAILED DESCRIPTION

According to one embodiment, an ultrasonic probe includes a first vibrating element and a second vibrating element. The first vibrating element is configured to vibrate at a first peak frequency. An intensity of a vibration of the first vibrating element is highest at the first peak frequency. The second vibrating element is configured to vibrate at a second peak frequency lower than the first peak frequency. An intensity of a vibration of the second vibrating element is highest at the second peak frequency.

According to one embodiment, an ultrasonic probe includes a first vibrating element and a second vibrating element. The first vibrating element includes a first piezoelectric layer. The first piezoelectric layer has a first thickness. The second vibrating element includes a second piezoelectric layer. The second piezoelectric layer has a second thickness. The second thickness is thicker than the first thickness.

According to one embodiment, an ultrasonic inspection device includes the ultrasonic probe according to one of the above, and a controller configured to perform the first operation. In the first operation, the controller supplies a first signal to the first vibrating element and causes an ultrasonic waves to emit from the first vibrating element. In the first operation, the controller acquires a second signal obtained from the second vibrating element. A reflected wave of the ultrasonic waves is incident on the second vibrating element. In the first operation, the controller outputs a first inspection signal corresponding to the second signal.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

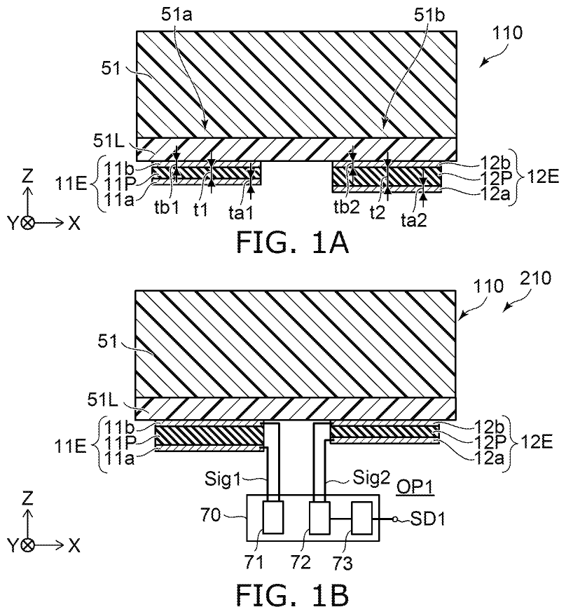

FIGS. 1A and 1B are schematic cross-sectional views illustrating an ultrasonic probe according to a first embodiment.

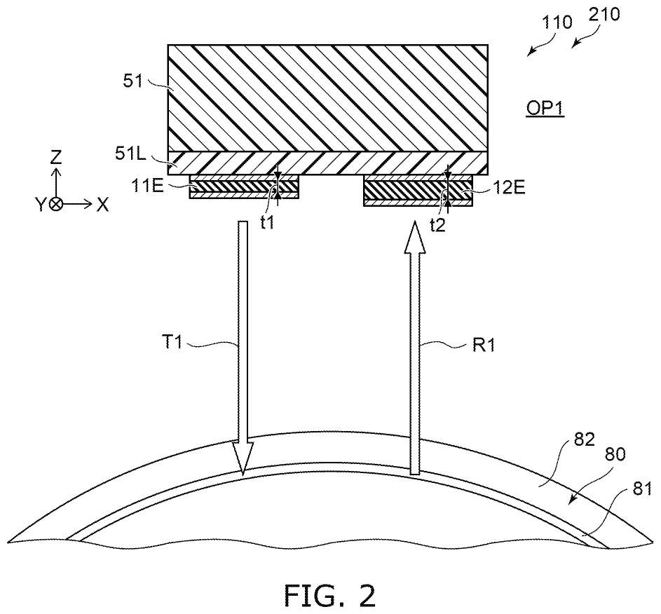

FIG. 2 is a schematic view illustrating an operation of the ultrasonic probe and the ultrasonic inspection device according to the first embodiment.

As shown in FIG. 1A, an ultrasonic probe 110 according to the embodiment includes a first vibrating element 11E and a second vibrating element 12E. The first vibrating element 11E can vibrate at the first peak frequency. The vibration intensity of the first vibrating element 11E becomes the highest at the first peak frequency. The second vibrating element 12E can vibrate at the second peak frequency. The vibration intensity of the second vibrating element 12E becomes the highest at the second peak frequency. The second peak frequency is lower than the first peak frequency. Thus, a plurality of vibrating elements having different peak frequencies are provided. As a result, an inspection target can be inspected with high accuracy.

In this example, the ultrasonic probe 110 further includes a first member 51. The first member 51 includes a first region 51a and a second region 51b. The first vibrating element 11E is fixed to the first region 51a. The second vibrating element 12E is fixed to the second region 51b. In this example, the ultrasonic probe 110 further includes a first adhesive layer 51L. A part of the first adhesive layer 51L is provided between the first vibrating element 11E and the first region 51a. Another part of the first adhesive layer 51L is provided between the second vibrating element 12E and the second region 51b.

The first member 51 includes, for example, a resin. The first member 51 includes, for example, an elastic body. The first member 51 functions as, for example, a backing material. The first member 51 attenuates an ultrasonic wave traveling toward the back surface side among the ultrasonic waves generated from the vibrating element, for example. The first adhesive layer 51L fixes the vibrating element and the first member 51 to each other. The first adhesive layer 51L includes, for example, a resin.

The first vibrating element 11E includes a first piezoelectric layer 11P. The first vibrating element 11E further includes a first electrode 11a and a first counter electrode 11b. The first piezoelectric layer 11P is located between the first electrode 11a and the first counter electrode 11b. In this example, the first piezoelectric layer 11P is located between the first electrode 11a and the first member 51 (first adhesive layer 51L). The first counter electrode 11b is located between the first piezoelectric layer 11P and the first member 51 (first adhesive layer 51L).

The second vibrating element 12E includes a second piezoelectric layer 12P. The second vibrating element 12E further includes a second electrode 12a and a second counter electrode 12b. The second piezoelectric layer 12P is located between the second electrode 12a and the second counter electrode 12b. In this example, the second piezoelectric layer 12P is provided between the second electrode 12a and the first member 51 (first adhesive layer 51L). The second counter electrode 12b is provided between the second piezoelectric layer 12P and the first member 51 (first adhesive layer 51L).

A first direction from the first electrode 11a to the first counter electrode 11b is defined as a Z-axis direction. One direction perpendicular to the Z-axis direction is defined as an X-axis direction. The direction perpendicular to the Z-axis direction and the X-axis direction is defined as a Y-axis direction. The electrodes and piezoelectric layer spread substantially parallel to the X-Y plane.

For example, when a voltage is applied between the first electrode 11a and the first counter electrode 11b, the thickness t1 of the first piezoelectric layer 11P changes. As a result, an ultrasonic wave T1 is emitted from the first vibrating element 11E (see FIG. 2). The first vibrating element 11E functions as, for example, an oscillating element.

As shown in FIG. 2, the ultrasonic wave T1 is incident on the inspection target 80 and a reflected wave R1 is generated. For example, when the reflected wave R1 (ultrasonic wave) is incident on the second vibrating element 12E, a force is applied to the second piezoelectric layer 12P by the incident reflected wave R1. For example, the thickness t2 of the second piezoelectric layer 12P changes. As a result, a voltage is generated between the second electrode 12a and the second counter electrode 12b. The second vibrating element 12E functions as, for example, a receiving element.

In the embodiment, a first operation OP1 cab be performed. In the first operation OP1, the ultrasonic wave T1 is emitted from the first vibrating element 11E and is incident on the inspection target 80. The ultrasonic wave T1 is reflected by the inspection target 80 and the reflected wave R1 is generated. When the reflected wave R1 is incident on the second vibrating element 12E, a received signal is obtained from the second vibrating element 12E. The inspection target 80 is inspected based on the received signal. The first peak frequency of the ultrasonic wave T1 emitted from the first vibrating element 11E substantially coincides with the first resonance frequency of the first vibrating element 11E. Alternatively, the first peak frequency is very close to the first resonance frequency. The ratio of the absolute value of the difference between the first peak frequency and the first resonance frequency to the first resonance frequency is, for example, 10% or less.

The second peak frequency of the second vibrating element 12E substantially coincides with the second resonance frequency of the second vibrating element 12E. Alternatively, the second peak frequency is very close to the second resonance frequency. The ratio of the absolute value of the difference between the second peak frequency and the second resonance frequency to the second resonance frequency is, for example, 10% or less.

As shown in FIG. 2, in this example, the inspection target 80 is an inspection target membrane 81. A structure body 82 exists between the inspection target 80 and the ultrasonic probe 110. The structure body 82 is, for example, a chamber. An inspection target film 81 (inspection target 80) is provided on the inner surface of the wall of the chamber. For example, the inspection target film 81 is a thin film of a liquid (for example, water). The ultrasonic wave T1 passes through the structure body 82 and reaches the inspection target 80 (inspection target membrane 81). Then, the reflected wave R1 reflected by the inspection target 80 (inspection target film 81) passes through the structure body 82 and is incident on the second vibrating element 12E.

In such an example of the inspection state, when the ultrasonic wave T1 passes through the structure body 82 and the reflected wave R1 passes through the structure body 82, there is a case where the frequency characteristics (frequency distribution) of the ultrasonic wave change significantly. For example, a high frequency component included in the ultrasonic wave T1 emitted from the first vibrating element 11E is attenuated when passing through the structure body 82. Further, a high frequency component included in the reflected wave R1 reflected by the inspection target 80 is attenuated by the structure body 82. As a result, the peak frequency of the reflected wave R1 incident on the second vibrating element 12E may be lower than the peak frequency of the ultrasonic wave T1 emitted from the first vibrating element 11E.

In the embodiment, the second peak frequency of the second vibrating element 12E on which the reflected wave R1 is incident is lower than the first peak frequency of the first vibrating element 11E. In the second vibrating element 12E, high sensitivity can be obtained at the second peak frequency being low. As a result, the reflected wave R1 having a reduced peak of the frequency component can be inspected with high sensitivity in the second vibrating element 12E.

In an ultrasonic inspection device of a reference example, the ultrasonic waves emitted from one vibrating element are reflected by the inspection target and become reflected waves. This reflected wave is incident on the one vibrating element and received. In the reference example, one vibrating element functions as a transmitting/receiving element. If the frequency characteristics (frequency distribution) of the ultrasonic waves do not change substantially in the space between the ultrasonic probe and the inspection target, it is possible to inspect the inspection target by receiving the reflected wave by the transmitting/receiving element as in the reference example.

However, as described above, there is a case where the frequency characteristic of the reflected wave R1 greatly changes from the frequency characteristic of the emitted ultrasonic wave T1 due to the object (structure body 82) existing between the ultrasonic probe and the inspection target. In this case, in the reference example in which the reflected wave is received by one transmitting/receiving element having one frequency characteristic (peak frequency), the frequency characteristic of the reflected wave R1 greatly deviates from the frequency characteristic of the transmitting/receiving element. Therefore, in the reference example, it is difficult to inspect the inspection target with high accuracy.

On the other hand, in the embodiment, as described above, a plurality of vibrating elements having different peak frequencies are provided. As a result, even if the frequency characteristics of the ultrasonic waves change due to an object (structure body 82) existing between the ultrasonic probe 110 and the inspection target 80, the inspection target 80 can be inspected with high accuracy. High accuracy can be maintained.

In the embodiment, an ultrasonic probe capable of improving accuracy can be provided. The resonance frequency of the vibrating element is inversely proportional to the thickness of the piezoelectric layer. The first piezoelectric layer 11P has a first thickness t1. The second piezoelectric layer 12P has a second thickness t2. The second thickness t2 is thicker than the first thickness t1. As a result, the first peak frequency of the first vibrating element 11E becomes higher than the second peak frequency of the second vibrating element 12E. These thicknesses are, for example, lengths along the first direction (Z-axis direction).

In one example, the first thickness t1 is, for example, not less than 40 μm and not more than 200 μm. The second thickness t2 is, for example, not less than 100 μm and not more than 400 μm.

As shown in FIG. 1B, the controller 70 may include a transmission circuit 71, a receiving circuit 72, and a processing circuit 73.

For example, in the first operation OP1, the transmission circuit 71 supplies a first signal Sig1 (for example, a voltage signal) to the first vibrating element 11E, and causes the ultrasonic wave T1 to emit from the first vibrating element 11E (see FIG. 2). For example, the transmission circuit 71 supplies the first signal Sig1 (for example, a voltage signal) between the first electrode 11a and the first counter electrode 11b. The ultrasonic wave T1 is emitted from the first vibrating element 11E. The peak frequency of the ultrasonic wave T1 corresponds to the first resonance frequency of the first vibrating element 11E. The ultrasonic wave T1 is reflected by the inspection target 80 to generate a reflected wave R1 (see FIG. 2). The reflected wave R1 is incident on the second vibrating element 12E.

The receiving circuit 72 acquires a second signal Sig2 obtained from the second vibrating element 12E on which the reflected wave R1 reflected by the inspection target 80 is incident in the first operation OP1. For example, the second signal Sig2 corresponding to the reflected wave R1 is generated between the second electrode 12a and the second counter electrode 12b. The receiving circuit 72 may obtain the second signal Sig2 and perform processing such as amplification.

As shown in FIG. 1B, the signal corresponding to the second signal Sig2 is supplied from the receiving circuit 72 to the processing circuit 73. The processing circuit 73 derives a first inspection signal SD1 based on the second signal Sig2 in the first operation OP1. The first inspection signal SD1 is output from the controller 70.

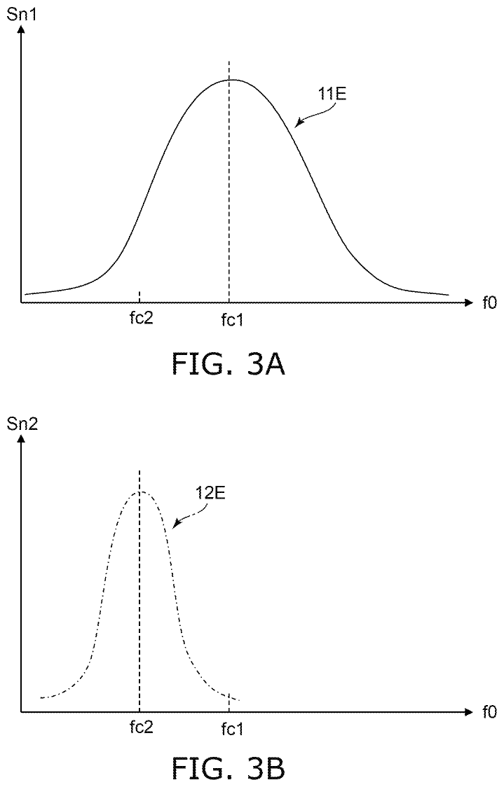

FIGS. 3A and 3B are schematic views illustrating the characteristics of the ultrasonic probe according to the first embodiment.

The horizontal axis of these figures (graphs) is the frequency f0. The vertical axis of FIG. 3A is the vibration intensity Sn1 in the first vibrating element 11E. When the first vibrating element 11E is used as a transmitting element, the intensity Sn1 corresponds to the intensity of the frequency component included in the ultrasonic wave T1 emitted from the first vibrating element 11E. When the first vibrating element 11E is used as the receiving element, the intensity Sn1 corresponds to the reception sensitivity. The vertical axis of FIG. 3B is the vibration intensity Sn2 in the second vibrating element 12E. When the second vibrating element 12E is used as the receiving element, the intensity Sn2 corresponds to the reception sensitivity.

As shown in FIG. 3A, the first vibrating element 11E has a first peak frequency fc1. For example, the intensity of the ultrasonic wave emitted from the first vibrating element 11E becomes substantially a peak at the first peak frequency fc1.

As shown in FIG. 3B, the second vibrating element 12E has a second peak frequency fc2. The second peak frequency fc2 is lower than the first peak frequency fc1. The reception sensitivity of the second vibrating element 12E become a peak at the second peak frequency fc2.

In one example, the first peak frequency fc1 is, for example, not less than 25 MHz and not more than 35 MHz, and is 30 MHz, for example. In one example, the second peak frequency fc2 is not less than 10 MHz and not more than 20 MHz, and is 15 MHz, for example.

FIG. 4 is a schematic view of the ultrasonic probe according to the first embodiment.

The horizontal axis of FIG. 4 (graph) is the frequency f0. The vertical axis of FIG. 4 is the intensity Int of the ultrasonic wave T1 emitted from the first vibrating element 11E or the intensity Int of the reflected wave R1 incident on the second vibrating element 12E.

As shown in FIG. 4, the second frequency f2 having the highest intensity Int in the reflected wave R1 is lower than the first frequency f1 having the highest intensity Int in the ultrasonic wave T1. This is because the high frequency component is attenuated when the ultrasonic wave T1 and the reflected wave R1 pass through the structure body 82.

The first frequency f1 substantially coincides with, for example, the first peak frequency fc1. The second peak frequency fc2 can be substantially matched to the second frequency f2.

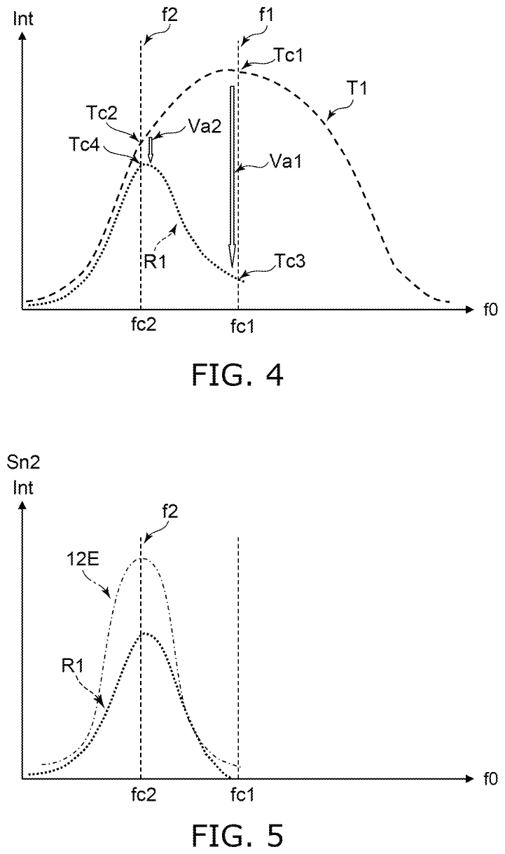

FIG. 5 is a schematic view illustrating the characteristics of the ultrasonic probe according to the first embodiment.

The horizontal axis of FIG. 5 (graph) is the frequency f0. The vertical axis of FIG. 5 is the intensity Sn2 or the intensity Int. In FIG. 5, the vibration characteristic of the second vibrating element 12E (see FIG. 3B) and the characteristic of the reflected wave R1 (see FIG. 4) are superimposed and illustrated. The second peak frequency fc2 is close to the second frequency f2. As a result, the reflected wave R1 whose frequency characteristic has changed to the low frequency side can be inspected with high sensitivity by the second vibrating element 12E. As a result, the inspection target 80 can be inspected with high accuracy. According to the embodiment, an ultrasonic probe capable of improving accuracy is provided.

As described above, in the first operation OP1, the ultrasonic wave T1 emitted from the first vibrating element 11E passes through the structure body 82 and is incident on the inspection target 80. The reflected wave R1 reflected by the inspection target 80 passes through the structure body 82 and is incident on the second vibrating element 12E. As shown in FIG. 4, the ultrasonic wave T1 includes a first component Tc1 having a first frequency f1 and a second component Tc2 having a second frequency f2. The second frequency f2 is lower than the first frequency f1. The reflected wave R1 includes a third component Tc3 having a first frequency f1 and a fourth component Tc4 having a second frequency f2.

The intensity Int of the third component Tc3 is lower than the intensity Int of the first component Tc1. An absolute value of the difference between the intensity Int of the first component Tc1 and the intensity Int of the third component Tc3 is defined as an absolute value Va1. An absolute value of the difference between the intensity Int of the second component Tc2 and the intensity Int of the fourth component Tc4 is defined as an absolute value Va2. The absolute value Va1 is larger than the absolute value Va2.

These absolute values correspond to the degree of attenuation in the structure body 82. For example, the degree of attenuation of the first component Tc1 in the structure body 82 is greater than the degree of attenuation of the second component Tc2 in the structure body 82.

Even in an inspection situation where such frequency characteristics can be obtained, the reflected wave R1 can be inspected with high sensitivity in the embodiment. Highly accurate inspection is possible.

In the example of the inspection state illustrated in FIG. 2, the inspection target 80 is the inspection target film 81. The thickness of the film 81 to be inspected is, for example, not less than 0.1 μm and not more than 100 μm. The frequency of the ultrasonic wave T1 is higher than the frequency used for general ultrasonic inspection (for example, not less than 2 MHz and not more than 5 MHz). In the embodiment, the peak frequency of the ultrasonic wave T1 is, for example, not less than 25 MHz and not more than 35 MHz, and is 30 MHz, for example. By using the ultrasonic wave T1 having such a high peak frequency, the inspection target film 81 (thin film) can be inspected.

When the ultrasonic wave T1 having a high peak frequency is used, the degree of attenuation in the structure body 82 through which the ultrasonic wave T1 passes and the reflected wave R1 passes becomes large. For example, in the case of low frequencies (for example, not less than 2 MHz and not more than 5 MHz) used for general ultrasonic inspection, the attenuation in the structure body 82 is substantially negligible.

When the inspection target 80 is the inspection target film 81 (thin film), a high frequency is used, and the degree of attenuation in the structure body 82 becomes large, the frequency characteristics (frequency distribution) as described above change. Even in the inspection situation of such a special situation, according to the configuration according to the embodiment, the inspection target film 81 (thin film) of the inspection target 80 can be inspected with high accuracy.

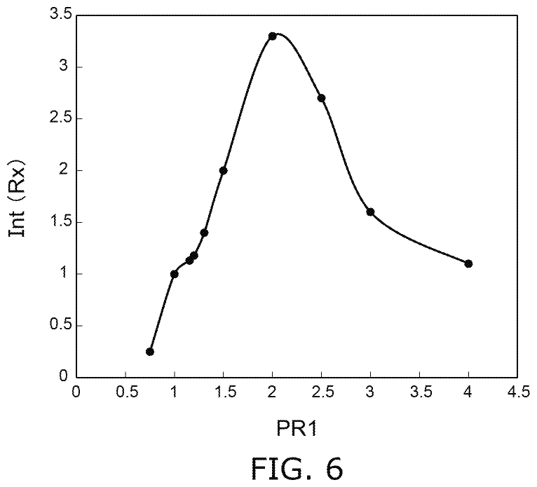

FIG. 6 is a graph illustrating the characteristics of the ultrasonic probe.

The horizontal axis of FIG. 6 is a peak frequency ratio RR1 (=fc1/fc2). The vertical axis is a parameter Int (Rx). The parameter Int (Rx) corresponds to the reception sensitivity of the receiving side oscillator Rx. In this example, the parameter Int (Rx) is standardized by the reception sensitivity of the receiving side oscillator Rx when the peak frequency of the receiving side oscillator Rx is the same as the peak frequency of the transmitting side oscillator Tx. As described above, when the ratio RR1 is 1, the high frequency component is greatly attenuated in the received ultrasonic wave. The graph is standardized with the reception sensitivity at this time as being 1.

When the ratio RR1 is 2, the peak frequency of the transmitting side oscillator Tx is 30 MHz, and the peak frequency of the receiving side oscillator Rx is 15 MHz. The parameter Int (Rx) when the ratio RR1 is 2 is more than 3 times the parameter Int (Rx) when the ratio RR1 is 1. When the ratio RR1 is 3, the peak frequency of the transmitting side oscillator Tx is 30 MHz, and the peak frequency of the receiving side oscillator Rx is 10 MHz. The parameter Int (Rx) when the ratio RR1 is 3 exceeds 1.5 times the parameter Int (Rx) when the ratio RR1 is 1. When the ratio RR1 is 1.3, the peak frequency of the transmitting side oscillator Tx is 30 MHz, and the peak frequency of the receiving side oscillator Rx is 23 MHz. The parameter Int (Rx) when the ratio RR1 is 1.3 is about 1.4 times the parameter Int (Rx) when the ratio RR1 is 1.

As can be seen from FIG. 6, the ratio RR1 is preferably 1.25 or more. This gives a high parameter Int (Rx). For example, high reception sensitivity can be effectively obtained. The ratio RR1 may be 3 or less. A high parameter Int (Rx) is obtained. In the embodiment, the first peak frequency fc1 is preferably 1.25 times or more the second peak frequency fc2. As a result, high inspection accuracy can be obtained.

As described above, the first piezoelectric layer 11P included in the first vibrating element 11E has the first thickness t1. The second piezoelectric layer 12P included in the second vibrating element 12E has the second thickness t2. The second thickness t2 is preferably 1.25 times or more the first thickness t1. As a result, high inspection accuracy can be obtained.

### Second Embodiment

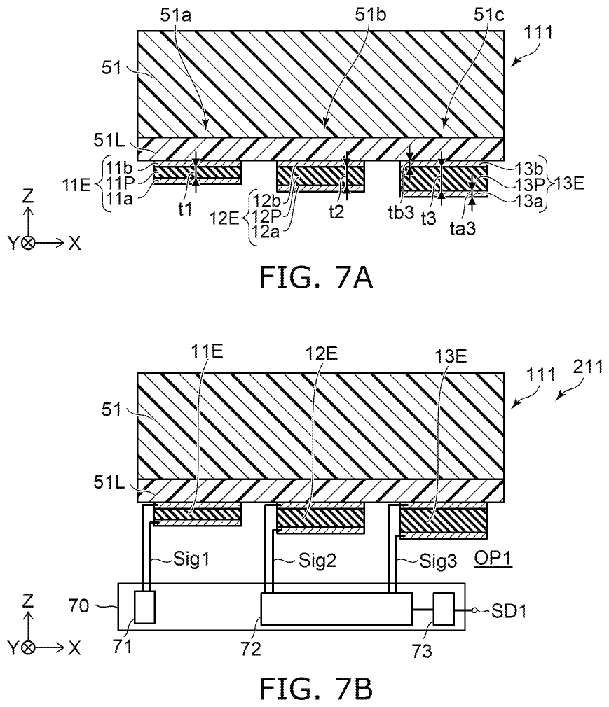

FIGS. 7A and 7B are schematic cross-sectional views illustrating an ultrasonic probe according to a second embodiment.

As shown in FIG. 7A, an ultrasonic probe 111 according to the embodiment includes the first vibrating element 11E, the second vibrating element 12E, and a third vibrating element 13E. Except for this, the configuration of the ultrasonic probe 111 may be the same as the configuration of the ultrasonic probe 110. In the ultrasonic probe 111, the third vibrating element 13E can vibrate at the third peak frequency.

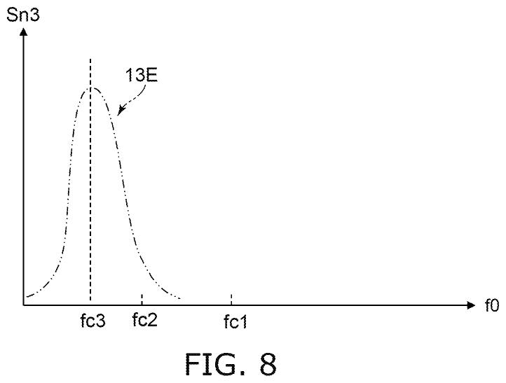

FIG. 8 is a schematic cross-sectional view illustrating the ultrasonic probe according to the second embodiment.

The horizontal axis in FIG. 8 is the frequency f0. The vertical axis of FIG. 8 is the vibration intensity Sn3 in the third vibrating element 13E. When the third vibrating element 13E is used as the receiving element, the intensity Sn3 corresponds to the reception sensitivity.

As shown in FIG. 8, the third peak frequency fc3 is lower than the first peak frequency fc1. The third peak frequency fc3 is different from the second peak frequency fc2. In this example, the third peak frequency fc3 is lower than the second peak frequency fc2. The third peak frequency fc3 may be between the first peak frequency fc1 and the second peak frequency fc2.

The third vibrating element 13E functions as a receiving element. By providing the third vibrating element 13E, it is possible to apply more types of inspection situations. For example, reception suitable for the characteristics of the reflected wave R1 in a wider range becomes easy.

For example, the first peak frequency fc1 is preferably 1.25 times or more the third peak frequency fc3.

As shown in FIG. 7A, the first vibrating element 11E includes the first piezoelectric layer 11P having the first thickness t1. The third vibrating element 13E includes a third piezoelectric layer 13P having a third thickness t3. The third thickness t3 is thicker than the first thickness t1. In this example, the third thickness t3 is thicker than the second thickness t2. The third thickness t3 may be between the first thickness t1 and the second thickness t2.

For example, the first member 51 includes the first region 51a, the second region 51b, and a third region 51c. The third vibrating element 13E is fixed to the third region 51c. A part of the first adhesive layer 51L may be provided between the third vibrating element 13E and the first member 51.

The third vibrating element 13E includes the third piezoelectric layer 13P, a third electrode 13a, and a third counter electrode 13b. The third piezoelectric layer 13P is located between the third electrode 13a and the third counter electrode 13b. In this example, the third piezoelectric layer 13P is provided between the third electrode 13a and the first member 51 (first adhesive layer 51L). The third counter electrode 13b is provided between the third piezoelectric layer 13P and the first member 51 (first adhesive layer 51L).

The first piezoelectric layer 11P, the second piezoelectric layer 12P, and the third piezoelectric layer 13P includes at least one selected from the group consisting of PbZnNbTiO₃ (lead zinc niobate), PbMgNbTiO₃ (lead magnesium niobate), PbZrTiO₃ (lead zirconate titanate), PbTiO₃ (lead titanate) and PbNbO₅ (lead niobate), for example. The ultrasonic wave T1 can be generated with high efficiency. For example, the reflected wave R1 can be inspected with high sensitivity. The lead zinc niobium titanate and the lead magnesium niobium titanate may be, for example, a piezoelectric single crystal. The lead zirconate titanate, lead titanate and lead niobate may be, for example, piezoelectric ceramics.

In the embodiment, the first electrode 11a, the second electrode 12a, and the third electrode 13a may include, for example, at least one selected from the group consisting of Ag, Ti, Cr, Ni, Cu, Au, and Pt. These electrodes may include oxides including In (e.g., Indium Tin Oxide, etc.). These electrodes may include stacked films including the above materials. These electrodes may include, for example, a baked silver electrode. These electrodes may be formed, for example, by at least one of plating, vapor deposition, and sputtering. These electrodes may be formed by metallizing, for example, by clad crimping or the like.

The thickness ta1 of the first electrode 11a, the thickness ta2 of the second electrode 12a, and the thickness ta3 of the third electrode 13a are, for example, not less than 0.05 μm and not more than 300 mm.

The first counter electrode 11b, the second counter electrode 12b, and the third counter electrode 13b may include, for example, at least one selected from the group consisting of Ag, Ti, Cr, Ni, Cu, Au, and Pt. These electrodes may include oxides including In (e.g., Indium Tin Oxide, etc.). These electrodes may include stacked films including the above materials. These electrodes may include, for example, a baked silver electrode. These electrodes may be formed, for example, by at least one of plating, vapor deposition, and sputtering.

The thickness tb1 of the first counter electrode 11b, the thickness tb2 of the second counter electrode 12b, and the thickness tb3 of the third counter electrode 13b are, for example, not less than 0.05 μm and not more than 300 mm.

As shown in FIG. 7B, the ultrasonic inspection device 211 includes the ultrasonic probe 111 and the controller 70. The receiving circuit 72 included in the controller 70 acquires the second signal Sig2 obtained from the second vibrating element 12E to which the reflected wave R1 reflected by the inspection target 80 is incident in the first operation OP1. Further, the receiving circuit 72 acquires the third signal Sig3 obtained from the third vibrating element 13E to which the reflected wave R1 reflected by the inspection target 80 is incident in the first operation OP1. For example, the second signal Sig2 corresponding to the reflected wave R1 is generated between the second electrode 12a and the second counter electrode 12b. For example, the third signal Sig3 corresponding to the reflected wave R1 is generated between the third electrode 13a and the third counter electrode 13b. In the receiving circuit 72, at least one of the signal corresponding to the second signal Sig2 and the signal corresponding to the third signal Sig3 is supplied from the receiving circuit 72 to the processing circuit 73. The processing circuit 73 derives the first inspection signal SD1 in the first operation OP1 based on at least one of the second signal Sig2 and the third signal Sig3. The first inspection signal SD1 is output from the controller 70.

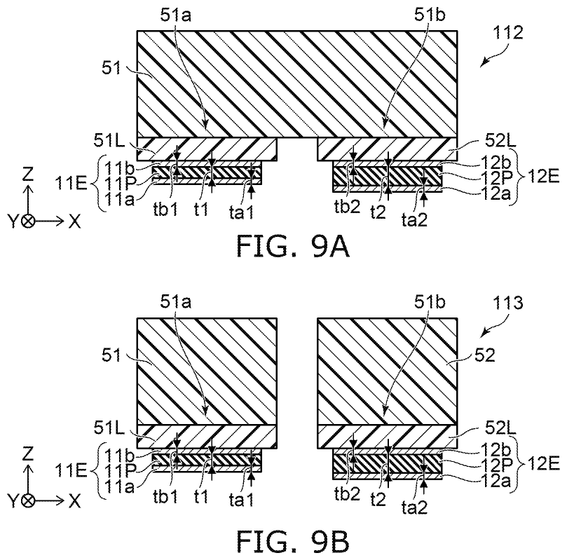

FIGS. 9A and 9B are schematic cross-sectional views illustrating an ultrasonic probe according to the embodiment.

As shown in FIG. 9A, an ultrasonic probe 112 according to the embodiment includes the first member 51, the first adhesive layer 51L, and a second adhesive layer 52L. Except for this, the configuration of the ultrasonic probe 112 may be the same as that of the ultrasonic probe 110.

The first member 51 includes the first region 51a and the second region 51b. The first adhesive layer 51L is provided between the first vibrating element 11E and the first region 51a. The second adhesive layer 52L is provided between the second vibrating element 12E and the second region 51b.

As shown in FIG. 9B, an ultrasonic probe 113 according to the embodiment includes the first member 51, a second member 52, a first adhesive layer 51L, and a second adhesive layer 52L. Except for this, the configuration of the ultrasonic probe 113 may be the same as that of the ultrasonic probe 110.

The first adhesive layer 51L is provided between the first vibrating element 11E and the first member 51. The second adhesive layer 52L is provided between the second vibrating element 12E and the second member 52.

In the embodiment, the planar shapes (shapes in the X-Y plane) of each of the first vibrating element 11E, the second vibrating element 12E, the third vibrating element 13E, the first member 51, the second member 52, the first adhesive layer 51L and the second adhesive layer 52L, are arbitrary. In one example, the planar shapes of the first vibrating element 11E, the second vibrating element 12E, and the third vibrating element 13E may be substantially circular.

### Third Embodiment

The third embodiment relates to an ultrasonic inspection device. The ultrasonic inspection apparatus 210 (see FIG. 1B) includes the ultrasonic probe (for example, the ultrasonic probe 110) according to the first embodiment or the second embodiment, and the controller 70 (see FIG. 1B). The controller 70 is configured to perform the first operation OP1.

In the first operation OP1, the controller 70 supplies the first signal Sig1 to the first vibrating element 11E and causes the ultrasonic wave T1 to emit from the first vibrating element 11E. The controller 70 acquires the second signal Sig2 obtained from the second vibrating element 12E to which the reflected wave R1 of the ultrasonic wave T1 is incident in the first operation OP1. The controller 70 outputs the first inspection signal SD1 corresponding to the second signal Sig2 in the first operation OP1.

As described above, the controller 70 may include the transmission circuit 71, the receiving circuit 72, and the processing circuit 73. In the first operation OP1, the transmission circuit 71 supplies the first signal Sig1 to the first vibrating element 11E and causes the ultrasonic wave T1 to emit from the first vibrating element 11E. The receiving circuit 72 acquires the second signal Sig2 obtained from the second vibrating element 12E to which the reflected wave R1 of the ultrasonic wave T1 is incident in the first operation OP1. The processing circuit 73 derives the first inspection signal SD1 based on the second signal Sig2 in the first operation OP1.

In the ultrasonic inspection device (for example, the ultrasonic inspection device 210) according to the embodiment, the second operation described below may be feasible.

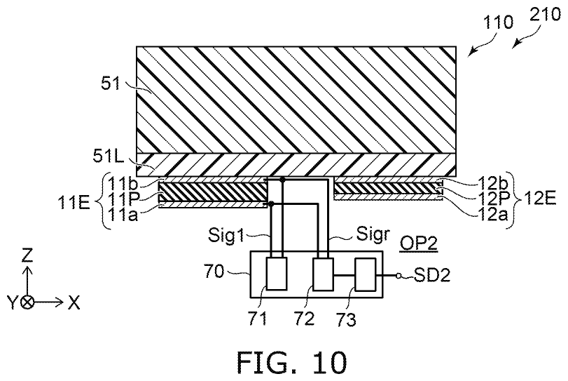

FIG. 10 is a schematic cross-sectional view illustrating the ultrasonic probe according to the embodiment.

The controller 70 is configured to perform the second operation OP2. In the second operation OP2, the controller 70 supplies the first signal Sig1 to one of the first vibrating element 11E and the second vibrating element 12E, and causes the ultrasonic wave T1 to emit from “the one” of the first vibrating element 11E and the second vibrating element 12E. In this example, “the one” is the first vibrating element 11E. In the second operation OP2, the controller 70 acquires the reflected signal Sigr obtained from “the one” to which the reflected wave R1 of the ultrasonic wave T1 is incident. The controller 70 outputs the second inspection signal SD2 corresponding to the reflection signal Sigr.

For example, the controller 70 may include the transmission circuit 71, the receiving circuit 72, and the processing circuit 73. In the second operation OP2, the transmission circuit 71 supplies the first signal Sig1 to “the one” and causes the ultrasonic wave T1 to emit from “the one”. In the second operation OP2, the receiving circuit 72 acquires the reflected signal Sigr obtained from “the one” to which the reflected wave R1 of the ultrasonic wave T1 is incident. The processing circuit 73 derives the second inspection signal SD2 based on the reflected signal Sigr in the second operation OP2.

The controller 70 may be able to switch between the first operation OP1 and the second operation OP2. Appropriate inspection according to the application becomes possible.

The embodiments may include the following configurations (for example, technical proposals).

### Configuration 1

An ultrasonic probe, comprising:

a first vibrating element configured to vibrate at a first peak frequency, an intensity of a vibration of the first vibrating element being highest at the first peak frequency; and

a second vibrating element configured to vibrate at a second peak frequency lower than the first peak frequency, an intensity of a vibration of the second vibrating element being highest at the second peak frequency.

### Configuration 2

The probe according to Configuration 1, wherein the first peak frequency is not less than 1.25 times the second peak frequency.

### Configuration 3

The probe according to Configuration 1 or 2, further comprising a third vibrating element configured to vibrate at a third peak frequency,

an intensity of a vibration of the third vibrating element being highest at the third peak frequency, and

the third peak frequency being lower than the first peak frequency and being different from the second peak frequency.

### Configuration 4

The probe according to Configuration 3, wherein the first peak frequency is not less than 1.25 times the third peak frequency.

### Configuration 5

The probe according to Configuration 3 or 4, wherein

the first vibrating element includes a first piezoelectric layer, the first piezoelectric layer has a first thickness,

the third vibrating element includes a third piezoelectric layer, the third piezoelectric layer has a third thickness, and

the third thickness is thicker than the first thickness.

### Configuration 6

The probe according to any one of Configuration 1 to 4, wherein

the first vibrating element includes a first piezoelectric layer, the first piezoelectric layer has a first thickness,

the second vibrating element includes a second piezoelectric layer, the second piezoelectric layer has a second thickness, and

the second thickness is thicker than the first thickness,

### Configuration 7

An ultrasonic probe, comprising:

a first vibrating element including a first piezoelectric layer, the first piezoelectric layer having a first thickness; and

a second vibrating element including a second piezoelectric layer, the second piezoelectric layer having a second thickness, the second thickness being thicker than the first thickness.

### Configuration 8

The probe according to Configuration 7, wherein the second thickness is not less than 1.25 times the first thickness.

### Configuration 9

The probe according to Configuration 7 or 8, further comprising a third vibrating element including a third piezoelectric layer, the third piezoelectric layer having a third thickness,

the third thickness is thicker than the first thickness and being different from the second thickness.

### Configuration 10

The probe according to any one of Configurations 6 to 9, wherein

the first vibrating element further includes a first electrode and a first counter electrode,

the first piezoelectric layer is located between the first electrode and the first counter electrode,

the second vibrating element further includes a second electrode and a second counter electrode, and

the second piezoelectric layer is located between the second electrode and the second counter electrode.

### Configuration 11

The ultrasonic probe according to any one of Configurations 1 to 10, further comprising a first member including a first region and a second region,

the first vibrating element being fixed to the first region, and

the second vibrating element being fixed to the second region.

### Configuration 12

The ultrasonic probe according to Configuration 11, further comprising a first adhesive layer provided between the first vibrating element and the first region.

### Configuration 13

The ultrasonic probe according to any one of Configurations 1 to 10, further comprising a first member and a second member,

the first vibrating element being fixed to the first member, and

the second vibrating element being fixed to the second member.

### Configuration 14

The probe according to Configuration 13, further comprising:

a first adhesive layer provided between the first vibrating element and the first member; and

a second adhesive layer provided between the second vibrating element and the second member.

### Configuration 15

An ultrasonic inspection device, comprising:

the ultrasonic probe according to any one of Configurations 1 to 14; and

a controller configured to perform the first operation,

in the first operation, the controller is configured to supply a first signal to the first vibrating element and to cause an ultrasonic waves to emit from the first vibrating element,

in the first operation, the controller is configured to acquire a second signal obtained from the second vibrating element, a reflected wave of the ultrasonic waves being incident on the second vibrating element, and

in the first operation, the controller is configured to output a first inspection signal corresponding to the second signal.

### Configuration 16

The device according to Configuration 15, wherein

the controller includes a transmission circuit, a receiving circuit, and a processing circuit,

in the first operation, the transmission circuit is configured supply the first signal to the first vibrating element and to cause the ultrasonic wave to emit from the first vibrating element,

in the first operation, the receiving circuit is configured to acquire the second signal obtained from the second vibrating element, the reflected wave of the ultrasonic wave being incident on the second vibrating element, and

in the first operation, the processing circuit is configured to derive the first inspection signal based on the second signal.

### Configuration 17

The device according to Configuration 15, wherein

the controller is configured to perform a second operation,

in the second operation, the controller is configured to supply the first signal to one of the first vibrating element and the second vibrating element and causes the ultrasonic wave to emit from the one,

in the second operation, the controller is configured to acquire the reflected signal obtained from the one of the first vibrating element and the second vibrating element, the reflected wave of the ultrasonic wave being incident on the one of the first vibrating element and the second vibrating element, and

in the second operation, the controller is configured to output a second inspection signal corresponding to the reflected signal.

### Configuration 18

The device according to Configuration 17, wherein

the controller includes a transmission circuit, a receiving circuit, and a processing circuit,

in the second operation, the transmission circuit is configured to supply the first signal to the one of the first vibrating element and the second vibrating element, and to cause the ultrasonic wave to emit from the one of the first vibrating element and the second vibrating element,

in the second operation, the receiving circuit is configured to acquire the reflected signal obtained from the one of the first vibrating element and the second vibrating element, the reflected wave of the ultrasonic wave being incident on the one of the first vibrating element and the second vibrating element, and

in the second operation, the processing circuit is configured to derive the second inspection signal based on the reflected signal.

### Configuration 19

The device according to Configuration 17 or 18, wherein the controller is configured to switch between the first operation and the second operation.

### Configuration 20

The device according to any one of Configurations 15 to 19, wherein

in the first operation,

the ultrasonic waves pass through a structure body and enter an inspection target,

the reflected wave reflected by the inspection target passes through the structure body and is incident on the second vibrating element,

the ultrasonic wave includes a first component of a first frequency and a second component of a second frequency,

the reflected wave includes a third component of the first frequency and a fourth component of the second frequency,

the second frequency is lower than the first frequency,

an intensity of the third component is lower than an intensity of the first component,

an absolute value of a difference between the intensity of the first component and the intensity of the third component is larger than an absolute value of a difference between an intensity of the second component and an intensity of the fourth component.

According to the embodiment, an ultrasonic probe and an ultrasonic inspection device capable of improving accuracy can be provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in ultrasonic probes and ultrasonic inspection devices such as first members, vibrating elements, electrodes, piezoelectric layers, circuits, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all ultrasonics probes and all ultrasonic inspection devices practicable by an appropriate design modification by one skilled in the art based on the ultrasonics probes and ultrasonic inspection devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An ultrasonic probe, comprising:
a first vibrating element configured to vibrate at a first peak frequency, an intensity of a vibration of the first vibrating element being highest at the first peak frequency; and
a second vibrating element configured to vibrate at a second peak frequency lower than the first peak frequency, an intensity of a vibration of the second vibrating element being highest at the second peak frequency.

2. The probe according to claim 1, wherein the first peak frequency is not less than 1.25 times the second peak frequency.

3. The probe according to claim 1, further comprising a third vibrating element configured to vibrate at a third peak frequency,
an intensity of a vibration of the third vibrating element being highest at the third peak frequency, and
the third peak frequency being lower than the first peak frequency and being different from the second peak frequency.

4. The probe according to claim 3, wherein the first peak frequency is not less than 1.25 times the third peak frequency.

5. The probe according to claim 3, wherein
the first vibrating element includes a first piezoelectric layer, the first piezoelectric layer has a first thickness,
the third vibrating element includes a third piezoelectric layer, the third piezoelectric layer has a third thickness, and
the third thickness is thicker than the first thickness.

6. The probe according to claim 1, wherein
the first vibrating element includes a first piezoelectric layer, the first piezoelectric layer has a first thickness,
the second vibrating element includes a second piezoelectric layer, the second piezoelectric layer has a second thickness, and
the second thickness is thicker than the first thickness.

7. An ultrasonic probe, comprising:
a first vibrating element including a first piezoelectric layer, the first piezoelectric layer having a first thickness; and
a second vibrating element including a second piezoelectric layer, the second piezoelectric layer having a second thickness, the second thickness being thicker than the first thickness.

8. The probe according to claim 7, wherein the second thickness is not less than 1.25 times the first thickness.

9. The probe according to claim 7, further comprising a third vibrating element including a third piezoelectric layer, the third piezoelectric layer having a third thickness,
the third thickness is thicker than the first thickness and being different from the second thickness.

10. The probe according to claim 6, wherein
the first vibrating element further includes a first electrode and a first counter electrode,
the first piezoelectric layer is located between the first electrode and the first counter electrode,
the second vibrating element further includes a second electrode and a second counter electrode, and
the second piezoelectric layer is located between the second electrode and the second counter electrode.

11. The probe according to claim 1, further comprising a first member including a first region and a second region,
the first vibrating element being fixed to the first region, and
the second vibrating element being fixed to the second region.

12. The probe according to claim 11, further comprising a first adhesive layer provided between the first vibrating element and the first region.

13. The probe according to claim 1, further comprising a first member and a second member,
the first vibrating element being fixed to the first member, and
the second vibrating element being fixed to the second member.

14. The probe according to claim 13, further comprising:
a first adhesive layer provided between the first vibrating element and the first member; and
a second adhesive layer provided between the second vibrating element and the second member.

15. An ultrasonic inspection device, comprising:
the ultrasonic probe according to claim 1; and
a controller configured to perform the first operation,
in the first operation, the controller is configured to supply a first signal to the first vibrating element and to cause an ultrasonic waves to emit from the first vibrating element,
in the first operation, the controller is configured to acquire a second signal obtained from the second vibrating element, a reflected wave of the ultrasonic waves being incident on the second vibrating element, and
in the first operation, the controller is configured to output a first inspection signal corresponding to the second signal.

16. The device according to claim 15, wherein
the controller includes a transmission circuit, a receiving circuit, and a processing circuit,
in the first operation, the transmission circuit is configured to supply the first signal to the first vibrating element and to cause the ultrasonic wave to emit from the first vibrating element,
in the first operation, the receiving circuit is configured to acquire the second signal obtained from the second vibrating element, the reflected wave of the ultrasonic wave being incident on the second vibrating element, and
in the first operation, the processing circuit is configured to derive the first inspection signal based on the second signal.

17. The device according to claim 15, wherein
the controller is configured to perform a second operation,
in the second operation, the controller is configured to supply the first signal to one of the first vibrating element and the second vibrating element and to cause the ultrasonic wave to emit from the one,
in the second operation, the controller is configured to acquire a reflected signal obtained from the one of the first vibrating element and the second vibrating element, the reflected wave of the ultrasonic wave being incident on the one of the first vibrating element and the second vibrating element, and
in the second operation, the controller is configured to output a second inspection signal corresponding to the reflected signal.

18. The device according to claim 17, wherein
the controller includes a transmission circuit, a receiving circuit, and a processing circuit,
in the second operation, the transmission circuit is configured to supply the first signal to the one of the first vibrating element and the second vibrating element, and to cause the ultrasonic wave to emit from the one of the first vibrating element and the second vibrating element,
in the second operation, the receiving circuit is configured to acquire the reflected signal obtained from the one of the first vibrating element and the second vibrating element, the reflected wave of the ultrasonic wave being incident on the one of the first vibrating element and the second vibrating element, and
in the second operation, the processing circuit is configured to derive the second inspection signal based on the reflected signal.

19. The device according to claim 17, wherein the controller is configured to switch between the first operation and the second operation.

20. The device according to claim 15, wherein
in the first operation,
the ultrasonic waves pass through a structure body and enter an inspection target,
the reflected wave reflected by the inspection target passes through the structure body and is incident on the second vibrating element,
the ultrasonic wave includes a first component of a first frequency and a second component of a second frequency,
the reflected wave includes a third component of the first frequency and a fourth component of the second frequency,
the second frequency is lower than the first frequency,
an intensity of the third component is lower than an intensity of the first component,
an absolute value of a difference between the intensity of the first component and the intensity of the third component is larger than an absolute value of a difference between an intensity of the second component and an intensity of the fourth component.
